(19) United States
(12) Patent Application Publication
(10) Pub. No.: US 2022/0023676 A1
(43) Pub. Date: Jan. 27, 2022

(54) WHISTLE MASK

(71) Applicant: Joseph Foster, Lynwood, IL (US)

(72) Inventor: Joseph Foster, Lynwood, IL (US)

(21) Appl. No.: 16/935,723

(22) Filed: Jul. 22, 2020

(51) Int. Cl. A62B 18/02; A62B 18/08

(52) U.S. Cl. CPC A62B 18/025; A62B 18/08

(57) ABSTRACT

During this day and time of COVID-19 with the influx of coronavirus infections and the desire and yearning of the public to return to some sense of normalcy particularly in the sports arena, sports officials need to feel safe on the playing courts and fields. This is where The Whistle Mask will help. This invention will create a new way for officials to be safe on the court while wearing a mask and still having the luxury of a whistle in their mouth while safely officiating the game. The body of the mask will cover the bridge of the nose and the mouth and have a pair of ear straps that loop around the ears. This mask will have a rectangular opening also named a port (FIG. 1) at the mouth to allow the insertion of a whistle. The upper portion of the port will be a flange covering (FIG. 2) that can be used to seal the port when the whistle is not inserted or being used.

### FIELD OF THE INVENTION

The present invention relates to a face mask, specifically a mask for sports officials with an outer mouth opening that allows for the insertion of a whistle with a flange that covers the opening of the mouth when the whistle is not in use.

### BACKGROUND OF THE INVENTION

During this day and time of COVID-19 sports officials need to feel safe on the playing courts and fields. As a NCAA official I had a hard time trying to officiate with a whistle in my mouth while wearing a mask to stay safe. I tried the handheld remote whistles but they were not loud enough and it was very awkward trying to do proper hand mechanics when making calls while having it in my hand. With that being said, this is a unique way to officiate safely wearing a mask without the hassle of the hand held device. There are several different types of masks available on the market but none specifically designed with sports officials in mind.

### SUMMARY OF THE INVENTION

This invention is a provision to a face mask having a covering for the nose and mouth, to include an outer mouth opening that serves as a port to allow for the insertion of a whistle with a flange that covers the opening of the mouth when the whistle is not in use.

This washable breathable mask will have a rubber nose guard that forms to the bridge of the nose and an aerodynamic fit that conforms to the face. It also will have a rectangular rubber whistle port in the mouth of the mask where the officials whistle can be inserted. This port will have a built in seal with a closable flange on top so when you remove your whistle the flange flips down and covers the port to prevent droplets from entering or exiting the mask. This mask will have flexible ear bands and cushions around the ear to ensure comfortability around the back of the ear (FIG. 1). This mask is not to be mistaken for a trainer's mask or a runner's athletic mask. The Whistle Mask is specifically designed for sports officials, providing them the ability to breathe while running and having a flexible fit. Most importantly it allows them to use their whistle while wearing PPE and staying safe while officiating.

### DRAWINGS

FIG. 1 is a frontal view of the mask with the flange closed

FIG. 2 is a side view of the mask with the flange closed

FIG. 3 is a frontal view of the mask with the flange opened

FIG. 4 is a side view of the mask with the flange opened

FIG. 5 is a side view of the open flange with a whistle inserted into the port

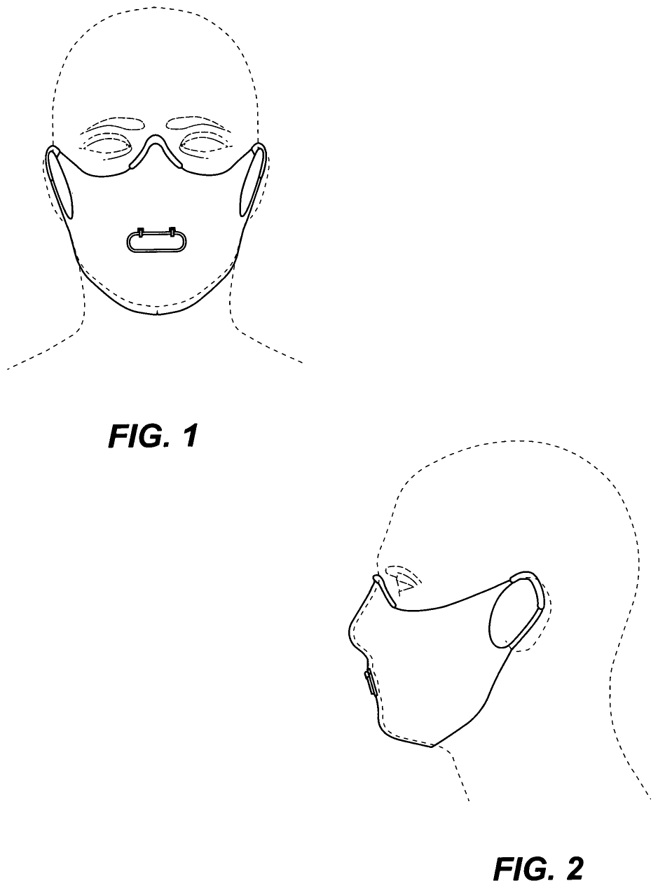

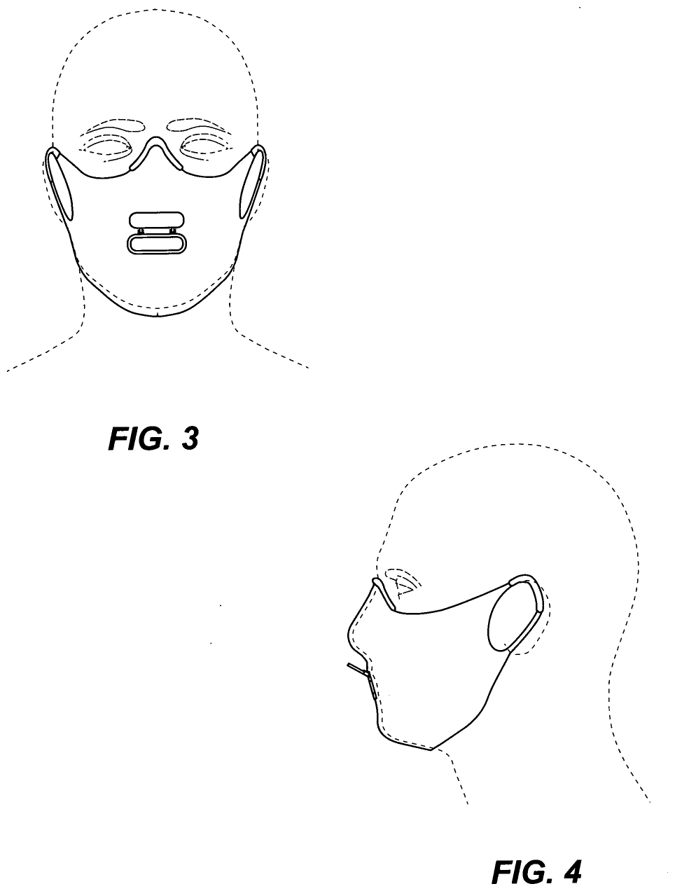

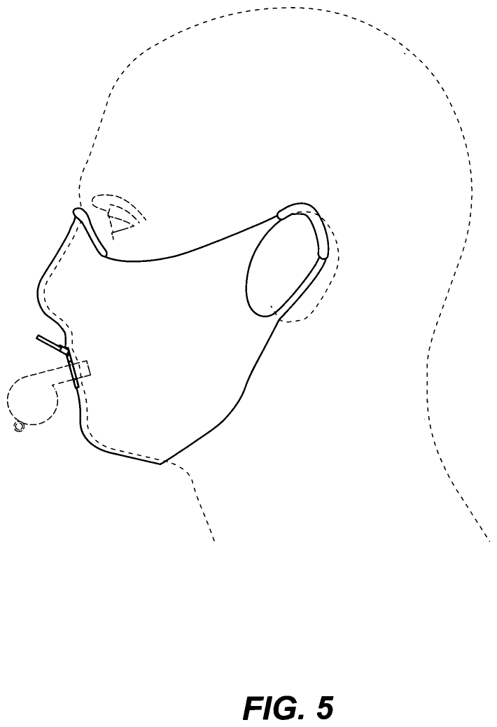

In the figure, 10—mask body, 12—rubber mouth port, 14—flange covering, 16—ear loops, 18—rubber nose guard, 20—opening for whistle.

### DESCRIPTION

The following describes the present invention with reference to the accompanying drawings. Referring to the attached drawings the face mask comprises a face mask body 10, that conforms to the shape of the face and nose, a rubber nose guard 18, cushioned ear loops that wrap around the ears 16, a rectangular rubber port mouth opening to insert the whistle 12, and a flange covering that closes the opening of the mouth port, 14.

1. The Whistle Mask is a washable breathable mask that covers the nose and mouth comprising: It will have a rubber nose guard that forms to the bridge of the nose and an aerodynamic fit that conforms to the face. It also will have a rectangular whistle port as part of the mouth opening where the officials whistle can be inserted. This mouth port will made of a rubber seal with a closable flange on top of the mouth port so when you remove your whistle the flange closes and covers the port to prevent droplets from entering or exiting the mask.
